(19) United States
(12) Patent Application Publication
(10) Pub. No.: US 2011/0144614 A1
(43) Pub. Date: Jun. 16, 2011

(54) SYRINGE GUIDE AND ASSOCIATED METHODS

(76) Inventor: Robert Hereford, Indian Harbour Beach, FL (US)

(21) Appl. No.: 12/965,181

(22) Filed: Dec. 10, 2010

Related U.S. Application Data
(60) Provisional application No. 61/285,794, filed on Dec. 11, 2009.

(51) Int. Cl. A61J 1/20

(52) U.S. Cl. 604/414

(57) ABSTRACT

A syringe guide may include a top portion adapted to receive a portion of a syringe, a medial portion extending downwardly from the top portion, and a bottom portion extending downwardly form the medial portion and adapted to receive a portion of a medication vial. The top portion may include top portion sidewalls and an end portion having an outer lip, the sidewalls defining a top portion having a semicircular shape. The medial portion may include medial portion sidewalls that extend substantially the length thereof and an upper portion including an upper lip having a semicircular shape. The medial portion sidewalls may include a passageway formed therethrough. The bottom portion may include a lower end, bottom portion sidewalls connected to and extending upwardly from the lower end, an upper end connected to the bottom portion sidewalls, and a locking mechanism adapted to receive and hold the medication vial. The bottom portion sidewalls may have a semicircular shape to define an open side to receive the medication vial.

### RELATED APPLICATIONS

The present application is related to and claims the benefit of U.S. Provisional Patent Application Ser. No. 61/285,794 titled SYRINGE GUIDE AND ASSOCIATED METHODS by the inventor of the present application filed on Dec. 11, 2009, the entire contents of which are incorporated herein by reference.

### FIELD OF THE INVENTION

The present invention relates to the field of prescription drug administration and, more specifically, to the field of guides for hypodermic needles and associated methods.

### BACKGROUND OF THE INVENTION

The use of needles to administer prescription medication is well known. Of course, needles are dangerous and can be the cause of transmission of certain diseases. This can generally be a problem, for example, in a hospital setting. Further, being inadvertently stuck by a needle is generally not a pleasant experience and, as such, it is desirous to avoid such a scenario.

There are several devices that have attempted to solve this problem. For example, U.S. Pat. No. 6,941,983 to Garukyan, discloses a syringe guide for guiding a needle of a syringe into a vial of medication. The design includes a base for engaging a medication vial, and a top for engaging a portion of a syringe. The top is connected to and extends outwardly from the base, and is separated from the base by a barrier. The top includes a continuous slit running the entire length thereof to allow for adjustability thereof to accommodate different size syringes.

U.S. Pat. No. 5,894,870 to Maxwell discloses a syringe guide and vial holder to facilitate insertion of a syringe into a medicine vial. The syringe guide includes a bottom portion having a semi-circular shape, a medial portion connected to the top portion and also having a semi-circular shape, and a top portion connected to the medial portion and having an open polygonal shape. The top portion is adapted to receive the syringe, while the bottom portion is adapted to receive the vial. The vial extends through the bottom portion and a top portion of the vial is adapted to rest in a recess formed in the medial portion.

U.S. Pat. No. 3,610,241 to LeMarie discloses a syringe guide that includes a bottom portion for engaging a vial, a medial portion having an open polygonal shape, and a top portion connected to the medial portion for engaging the syringe. The top portion includes a lip to engage a portion of the syringe to hold the syringe in place, and the bottom portion includes a recess formed therein to provide a resting place for a top portion of the vial. U.S. Pat. No. 4,219,055 to Wright discloses a syringe filling aid having a base that supports a vial, a medial portion connected to and extending upwardly from the base, and a top portion connected to the medial portion and adapted to hold a portion of the syringe.

U.S. Pat. No. 6,439,276 to Wood et al. discloses a kit for loading hypodermic needles and for disposing of used needles in a built-in sharps holder. The kit includes a base for retaining the syringe and the vial, and a cover that is hingedly connected to the base and may be moved from an open position to a closed position. When in the closed position, portions of the syringe and vial may be covered so that medication from the vial may be extracted by the syringe. U.S. Pat. No. 6,497,697 to Cohn discloses a simplistic syringe guide and vial holder. The Cohn '697 design includes a base having two vial wall members connected to a bottom portion thereof, and two syringe guide members connected to a top portion thereof.

U.S. Pat. No. 5,873,859 to Muntz discloses an apparatus for use by individuals that must self inject medication. The device includes a base having a pair of syringe holding members adapted to engage a syringe, and a clamp for holding the vial. The syringe holding members are fixedly connected to the base, while the clamp for holding the vial is moveably connected to the base on a track. A user may connect the syringe to the syringe holding members, and then connect the vial to the clamps. Thereafter, the vial may be moved into an engaged position so that medication may be extracted form the vial.

U.S. Pat. No. 4,439,193 to Larkin discloses an apparatus for connecting medical liquid containers to a flexible tubing port. This device is directed mainly to connecting IV bags, for example, to IV tubing. The device includes a base having a first end adapted to receive the end of the IV tubing having a piercing pin, and a second end adapted to receive an end port of an IV bag. An alignment track extends upwardly from the base of the device, and clamps for holding the IV tubing and the IV end port may be moved closer to one another so that the IV tubing may engage the IV end port.

There exists a need to provide a syringe guide that can be readily used to both hold a medication bottle and to guide a needle of a syringe into the medication bottle while simultaneously reducing the risk of sticking the user.

### SUMMARY OF THE INVENTION

With the foregoing in mind, it is therefore an object of the present invention to provide a syringe guide that allows for ready use of a syringe while simultaneously reducing the risk of being inadvertently stuck by a needle during use. It is also an object of the present invention to provide a syringe guide that allows a user to readily withdraw medicine from a vial using one handed operation. It is further an object of the present invention to provide a syringe guide that holds a medication vial in place while withdrawing medicine therefore. It is still further an object of the present invention to provide a syringe guide that stabilizes a medication vial while a user is extracting medication therefrom. It is yet another object of the present invention to provide a syringe guide that assists a user in withdrawing an accurate dosage from the medication vial.

These and other objects, features and objectives according to the present invention are provided by a syringe guide comprising a top portion adapted to receive a portion of a syringe, a medial portion extending downwardly from the top portion, and a bottom portion extending downwardly form the medial portion and adapted to receive a portion of a medication vial. The top portion may include top portion sidewalls and an end portion having an outer lip. The sidewalls may define a top portion having a semicircular shape. The medial portion may include medial portion sidewalls that extend substantially the length thereof. An upper portion of the medial portion may include an upper lip having a semicircular shape. The medial portion sidewalls may have a passageway formed therethrough.

The bottom portion may include a lower end and bottom portion sidewalls connected to and extending upwardly from the lower end. The bottom portion may also include an upper end connected to the bottom portion sidewalls, and a locking mechanism adapted to receive and hold the medication vial. The bottom portion sidewalls may have a semicircular shape to define an open side to receive the medication vial.

The outer lip of the top portion may be beveled, and the medial portion sidewalls may include a plurality of passageways formed therein. The passageways formed in the medial portion sidewalls may have an ovular shape. The syringe guide may also include a magnifier carried by the medial portion sidewalls. The magnifier may be provided by a magnifying glass carried by the passageway formed in the medial portion sidewalls.

The upper lip that extends outwardly from the upper portion of the medial portion of the syringe guide may have a semicircular shape and may be positioned to oppose the top portion sidewalls having the semicircular shape. The locking mechanism may include a lip that is formed along the lower end thereof. The lip of the locking mechanism may be defined by a structural element having an inner diameter that is smaller than an inner diameter of the bottom portion sidewalls. The syringe guide may also include a needle guard positioned between the bottom portion and the medial portion. The needle guard may include including a passageway formed through a medial portion thereof.

A method aspect of the present invention is for using the syringe guide. The method may include engaging the medication vial with the locking mechanism so that the medication vial is held by the locking mechanism. The method may also include engaging a syringe with the top portion of the syringe guide. The method may further include sliding the syringe through the medial portion of the syringe guide so that a needle of the syringe passes through a needle guard positioned between the medial portion and the bottom portion of the syringe guide.

### BRIEF DESCRIPTION OF THE DRAWINGS

FIG. 1 is an environmental view of a syringe guide according to the present invention.

FIG. 2 is a left side elevation view of a syringe guide according to the present invention.

FIG. 3 is a rear elevation view of a syringe guide according to the present invention.

FIG. 4 is a bottom plan view of a syringe guide according to the present invention.

FIG. 5 is a top plan view of a syringe guide according to the present invention.

FIG. 6 is a front elevation view of a syringe guide according to the present invention.

FIG. 7 is a right side elevation view of a syringe guide according to the present invention.

FIG. 8 is an exploded environmental view of a syringe guide according to the present invention showing a vial and a syringe.

FIG. 9 is an environmental view of a syringe guide according to the present invention showing a vial and a syringe detachably connected thereto.

FIG. 10 is an environmental view of another embodiment of the syringe guide according to the present invention.

FIG. 11 is an environmental view of the embodiment of the syringe guide illustrated in FIG. 10 and showing a medication vial connected thereto and syringe being guided from a first engaged position to a second engaged position.

FIG. 12 is a side elevation view of another embodiment of a syringe guide according to the present invention.

FIG. 13 is a front elevation view of the syringe guide illustrated in FIG. 12.

FIG. 14 is a top plan view of the syringe guide illustrated in FIG. 12.

FIG. 15 is a side elevation view from an opposite side of the syringe guide illustrated in FIG. 12.

FIGS. 16-19 are perspective views of the syringe guide illustrated in FIG. 12.

### DETAILED DESCRIPTION OF THE PREFERRED EMBODIMENT

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notations refer to like elements in different embodiments.

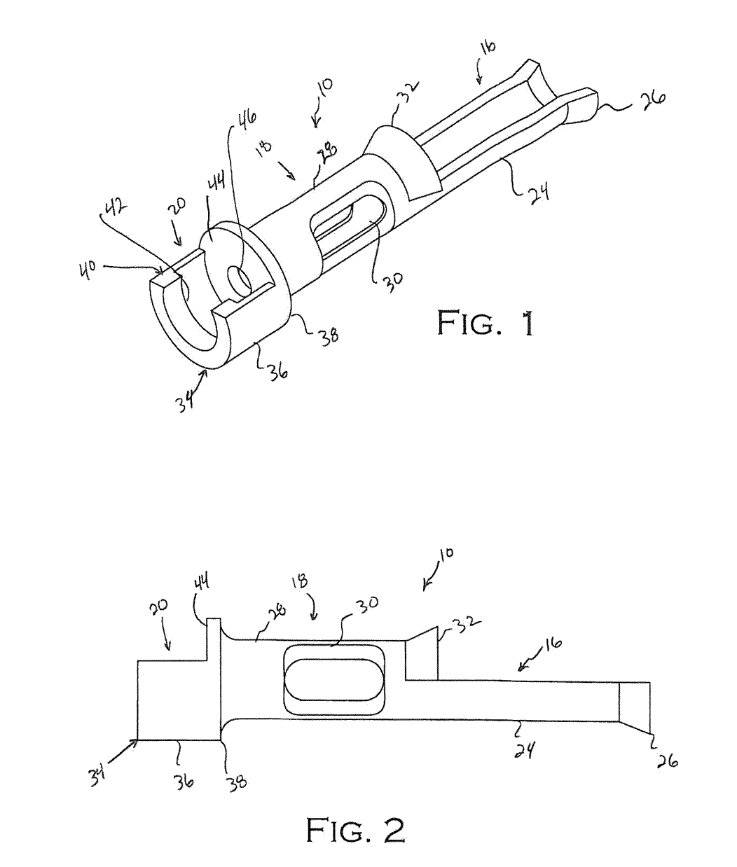

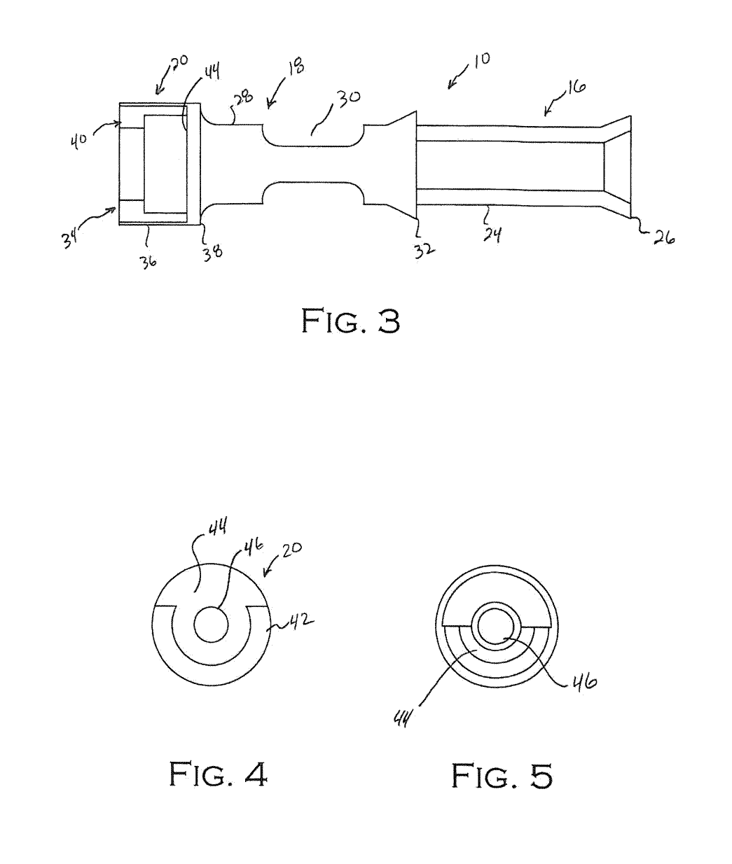

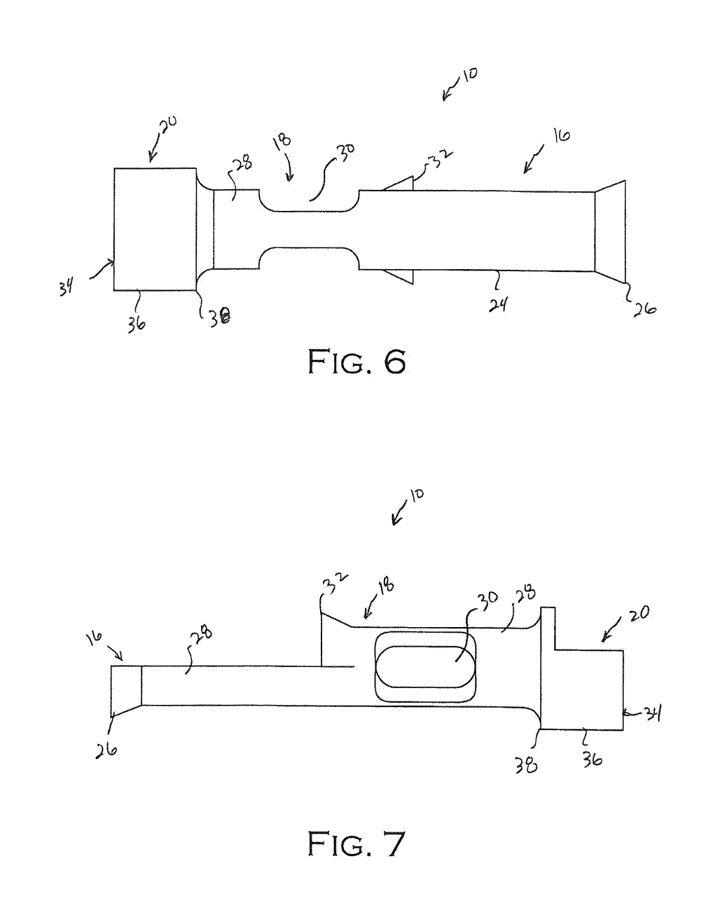

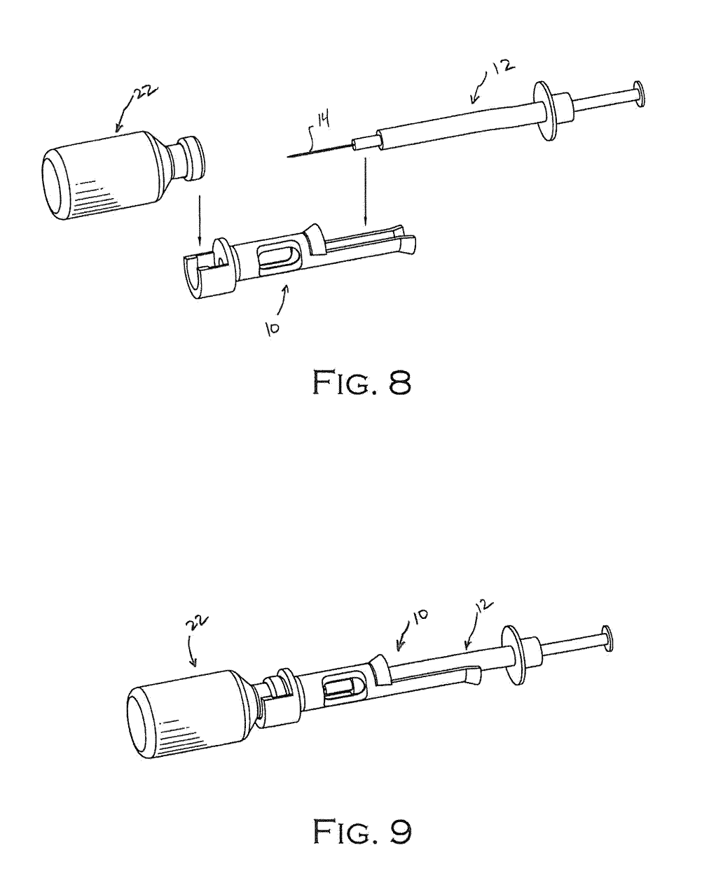

Referring now to FIGS. 1-9, details of the syringe guide 10 according to the present invention are now described in greater detail. The syringe guide 10 according to the present invention advantageously allows a user to readily fill a syringe 12 with medication from a medication vial 22 while simultaneously reducing the risk of the user being stuck with a needle 14 of the syringe. As will be discussed in greater detail below, the unique design of the syringe guide 10 includes a top portion 16, a medial portion 18 and a bottom portion 20. The medial portion 18 of the syringe guide 10 according to the present invention is adapted to join the top portion 16 and the bottom portion 20. More specifically, and as perhaps best illustrated in FIGS. 8 and 9, the top portion 16 of the syringe guide 10 is adapted to receive a portion of the syringe 12 so that the needle 14 of the syringe may be guided through the medial portion 18 of the syringe guide. The bottom portion 20 of the syringe guide 10 is adapted to receive a medication vial 22. The syringe guide 10 according to the present invention is advantageously adapted to hold the medication vial 22 in place while in use.

Referring now more specifically to FIGS. 1-7, individual portions of the syringe guide 10 according to the present invention will now be discussed in greater detail. The top portion 16 of the syringe guide 10 includes semi-circular shaped sidewalls 24. The top portion 16 also includes an end portion 26 having an outer lip. The outer lip advantageously enhances the guidance features of the syringe guide 10 according to the present invention. The outer lip is preferably beveled, but those skilled in the art will appreciate that the outer lip can have any shape and still achieve the goals, features and objectives according to the present invention.

The medial portion 18 of the syringe guide 10 is connected to and extends from the top portion 16 of the syringe guide. More specifically, the medial portion 18 may illustratively include sidewalls 28 that extend substantially the length of the medial portion. The sidewalls 28 may include at least one passageway 30 formed therein. The illustrated embodiment of the syringe guide 10 shows that two passageways 30 are formed in the medial portion 18 thereof and positioned opposite one another.

The passageways 30 formed in the sidewalls 28 of the medial portion 28 advantageously allow a user to view a portion of the syringe 12 to so that the amount of medication being extracted into the syringe from the medication vial 22 is readily visible. For example, and as perhaps best illustrated in FIG. 9, when both the medication vial 22 and the syringe 12 are engaged with the syringe guide 10, a portion of the syringe is visible through the passageways 30. To be specific, it is preferably for the portion of the syringe 12 that indicates the amount of medication that has been extracted into the syringe from the medication vial 22 be visible through the passageways 30. This advantageously allows a user to view how much medication has been dispensed into the syringe 12. This is important so that users of the syringe guide 10 according to the present invention can be sure to obtain the proper dosage of medication when using the syringe guide. The passageways 30 also advantageously allow a user to grip a portion of the syringe 12 to provide additional stability while extracting medication from the medication vial 22.

The passageways 30 formed in the medial portion 18 of the syringe guide 10 may include a magnifying glass (not shown). The magnifying glass can advantageously assist a user in viewing the portion of the syringe 12 into which the medication is extracted from the medication vial 22. Those skilled in the art will appreciate that the magnifying glass can be carried by both passageways 30 formed in the medial portion 18 of the syringe guide 10, or may only be carried by one of the passageways formed in the syringe guide. Both configurations can be advantageous. For example, positioning a magnifying glass to be carried by both passageways 30 can advantageously provide a user with flexibility in viewing the amount of medication being dispensed into the syringe 12 from the medication vial 22. More specifically, this configuration advantageously provides as much flexibility of use for both left handed users and right handed users. By providing the magnifying glass in one of the two illustrated passageways 30, however, one of the passageways may remain open so that a user can grip the syringe 12 while extracting medication from the medication vial 22. This configuration can be especially advantageous as it provides a user with both the ability to readily grip the syringe 12 while extracting medication from the medication vial 22 and the ability to readily view the amount of medication that has been dispensed into the syringe.

An upper portion of the medial portion 18 of the syringe guide 10 includes an upper lip 32. The upper lip 32 is a beveled portion that has a semicircular shape. More particularly, the upper lip 32 is connected to an upper portion of the medial portion 18 of the syringe guide 10, and extends substantially the circumference of the syringe guide opposite the semicircular shaped sidewalls 24 of the top portion 16 of the syringe guide. In other words, and as illustrated in the appended figures, the semicircular shape of the upper lip 32 is positioned opposite the semicircular shape of the sidewalls 24 of the top portion 16 of the syringe guide 10. The upper lip 32 advantageously enhances use of the syringe guide 10 by providing the user with additional guidance when inserting the needle 14 of a syringe 12 into the syringe guide.

The bottom portion 20 of the syringe guide 10 is now described in greater detail. The bottom portion 20 of the syringe guide 10 includes a lower end 34, sidewalls 36 extending upwardly from the lower end 34 and an upper end 38 connected to the sidewalls. The diameter of the bottom portion 20 of the syringe guide 10 is illustratively greater than the diameter of the medial portion 18, but those skilled in the art will appreciate that the diameter of the bottom portion of the syringe guide may be substantially similar to the diameter of the medial portion, or may be less than the diameter of the medial portion while still accomplishing the goals, features and objectives according to the present invention.

The bottom portion 20 of the syringe guide 10 includes a locking mechanism 40. The locking mechanism 40 is adapted to hold a medication vial 22 in place when medication is extracted therefrom using the syringe 12. More specifically, and as perhaps best illustrated in FIGS. 8-9, the medication vial 22 may be moved to an engaged position with the syringe guide 10 by engaging the top of the medication vial with the locking mechanism 40. The locking mechanism 40 includes a lip 42 that is formed along a lower end 34 of the bottom portion 20 of the syringe guide 10. The lip 42 is preferably defined by a structural element that has in inner diameter that is smaller than the inner diameter of the bottom portion 20 of the syringe guide 10.

The bottom portion 20 of the syringe guide 10 illustratively has a semicircular shape. The open side of the bottom portion 20 of the syringe guide 10 is adapted to receive the top portion of a medication vial 22 so that the medication vial may be held in place using the locking mechanism 40 while medication is extracted from the medication vial using a syringe 12.

A needle guard 44 may be positioned between the bottom portion 20 and the medial portion 18 of the syringe guide 10 according to the present invention. More particularly, the bottom portion 20 and the medial portion 18 of the syringe guide 10 may be separated by the needle guard 44. Depending on how it is characterized, the needle guard 44 can be considered a stand alone structural element, may be considered an upper end of the bottom portion 20 of the syringe guide 10, or may be considered an lower end of the medial portion 18 of the syringe guide. The needle guard 44 may be a substantially flat element having a passageway 46 formed therethrough. The passageway 46 may be characterized as a needle receiving passageway. The needle receiving passageway is adapted to receive the needle 14 of the syringe 12 as the syringe engages the top portion of the syringe guide 10 and is passed through the medial portion 18 of the syringe guide so that the needle can remain unexposed as it pierces a top portion of the medication vial 22 to extract the medication therefrom. The passageway 46 of the needle guard 44 is preferably small, i.e., significantly smaller than the inner diameter of the medial portion 18 of the syringe guide 10, and significantly larger than the diameter of a needle 14. Further, the passageway 46 of the needle guard 44 is preferably centered in the needle guard. This advantageously decreases the risk associated with breaking the needle 14 while trying to extract medication from the mediation vial 22.

In one embodiment of the syringe guide (not shown) the medial portion 18 of the syringe guide may have an interior conical shape. The interior conical shape can advantageously enhance the guidance of the needle 14 of the syringe 12 into the medication vial 22. This configuration can also be advantageous to prevent breaking of needles 14 when using the syringe guide 10 according to the present invention.

A method aspect of the present invention is for using a syringe guide 10 to fill a syringe with a predetermined amount of medication to be extracted from a medication vial 22. The method may include engaging a syringe 12 with the syringe guide 10. The method may also include engaging a medication vial 22 with a locking mechanism 40 of the syringe guide 10. The method may further include sliding the syringe 12 through the medial portion 18 of the syringe guide 10 so that a needle 14 of the syringe 12 pierces a top portion of the medication vial 22 and so that the medication can be removed from the medication vial while the medication vial is being held in place by the locking mechanism 40 of the syringe guide. The method may still further include removing the syringe 12 having the medication therein from the medication vial 22 by disengaging the syringe from the syringe guide and disengaging the medication vial from the locking mechanism 40.

The system and methods according to the present invention advantageously allow a user to readily fill a syringe 12 with medication from a medication vial 22 using only one handed operation, if so desired. The system and methods according to the present invention also advantageously greatly decrease the possibility of a user being stuck with a needle 14 while filling a syringe 12 with medication. The system and method according to the present invention further advantageously allow a user to readily view the amount of medication being dispensed from a medication vial 22 into a syringe 12 via the passageways 30 formed in the medial portion 18 of the syringe guide 10. The system and methods according to the present invention further advantageously allow a user to readily grip a syringe 12 while dispensing medication from a medication vial 22.

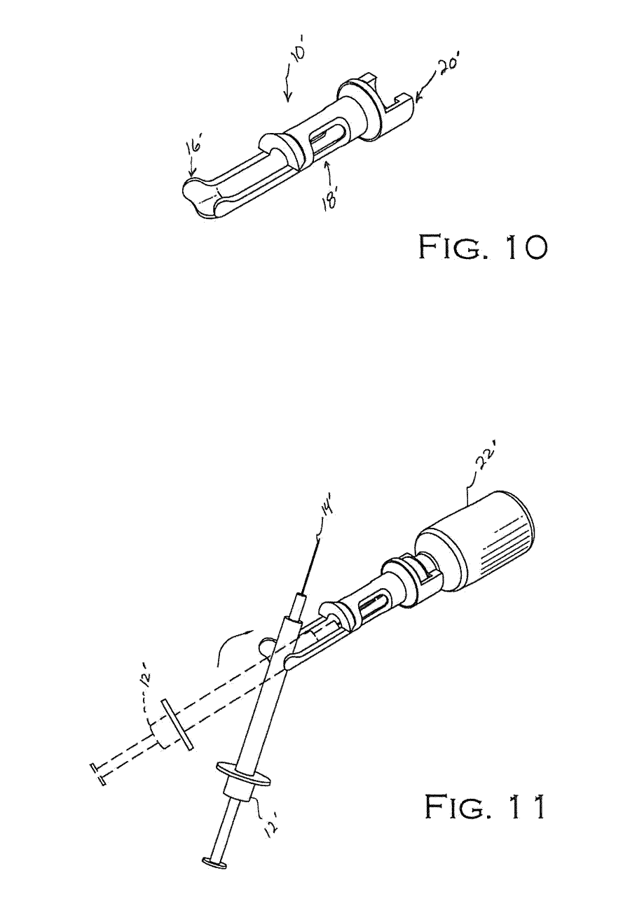

Referring now additionally to FIGS. 10-11, another embodiment of the syringe guide 10′ according to the present invention is now described in greater detail. More specifically, the top portion 16′ of the embodiment of the syringe guide 10′ illustrated in FIGS. 10-11 includes a flared end. The flared end of the top portion 16′ of the syringe guide 10′; advantageously allows the syringe 12′ to be smoothly moved between a first engaged position (illustrated with a solid line) and a second engaged position (illustrated with dotted lines). This configuration of the second embodiment of the syringe guide 10′ according to the present invention advantageously enhances use of the syringe guide. More specifically, the user may position the syringe 12′ in the first engaged position and move the syringe to a second engaged position, as illustrated in FIG. 11. After the syringe 12′ is moved from the first engaged position to the second engaged position, it can be moved forward along the top portion 16′ so that the needle 14′ passes through the medial portion 18′ of the syringe guide 10′ to extract medication from the medication vial 22′ connected to the bottom portion 20′ of the syringe guide. The remaining features of this embodiment of the syringe guide 10′ are similar to those of the first embodiment of the syringe guide 10, are labeled with prime notation and require no further discussion herein.

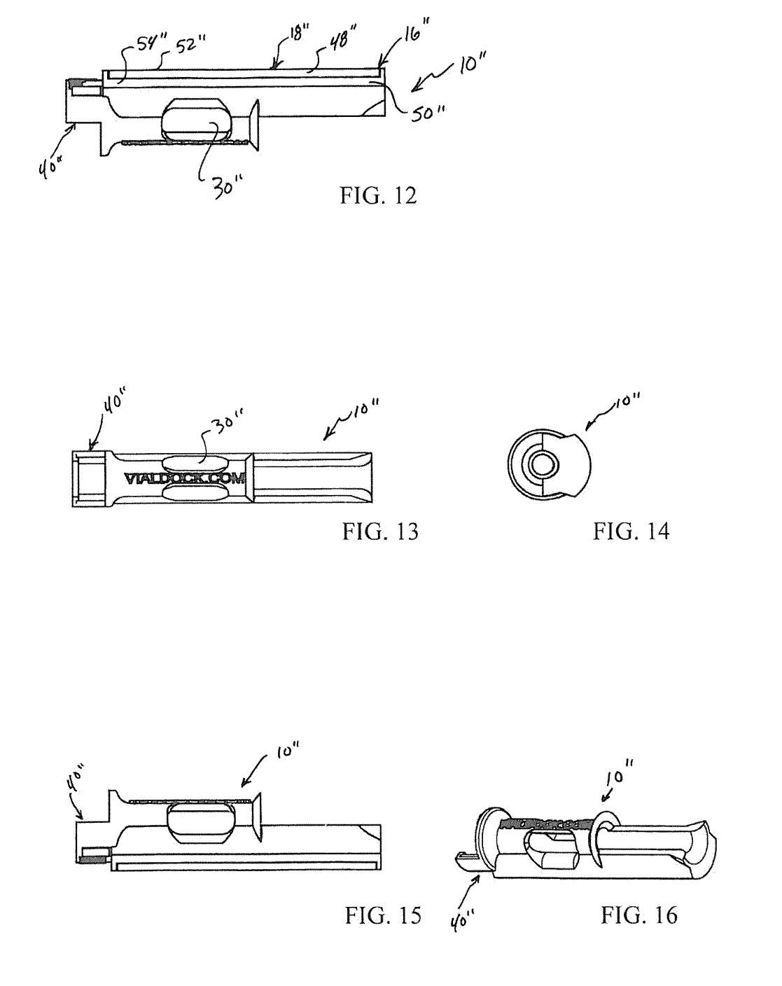

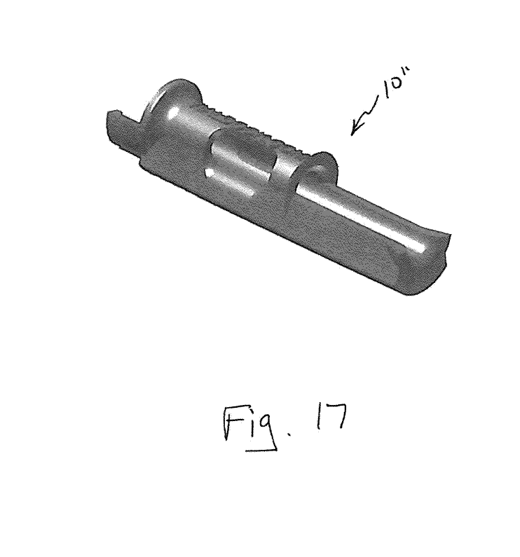

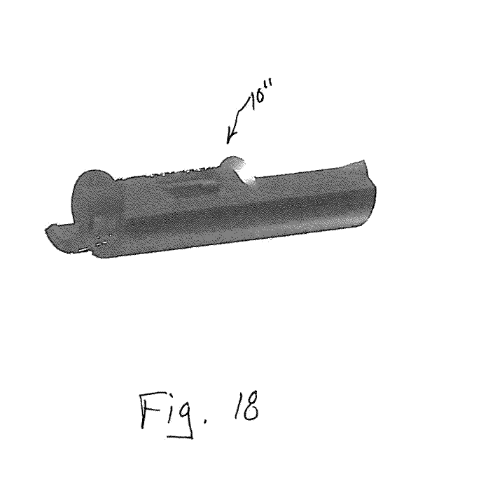

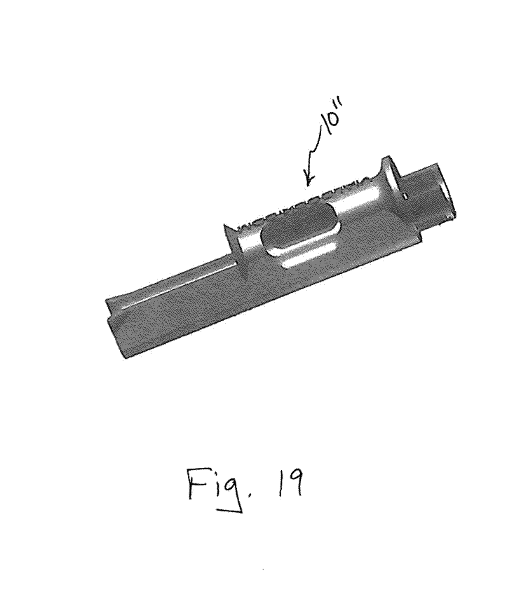

Referring now additionally to FIGS. 12-19, an alternate embodiment of the syringe guide 10″ is now described. The alternate embodiment of the syringe guide 10″ provides a different shape for the top portion 16″ and the medial portion 18″ than that of the first embodiment of the syringe guide 10. More particularly, the top portion 16″ may be characterized as including a base 48″ and sidewalls 50″extending upwardly from the base. Similarly, the medial portion 18″ may include a base 52″ and sidewalls 54″ extending upwardly therefrom. The base 48″ of the top portion 16″ and the base 52″ of the medial portion 18″ are aligned with one another to have a flush appearance throughout. Further, the base 52″ of the medial portion 18″ may be shaped such that the base acts as a magnifier to magnify the syringe as it is being used to withdraw medication from the medication vial. This advantageously allows for a user to more readily view the amount of medication being dispensed into the syringe from the medication vial.

As illustrated, this embodiment of the syringe guide 10″ still includes a bottom portion 20″, which also includes a locking mechanism 40″. In this embodiment of the syringe guide 10″, the locking mechanism 40″ may be defined as having a wall that is semi-circular in shape, and having an outer surface diameter that is smaller than the outer surface diameter of the sidewalls 28″ of the medial portion 18″. Further, the medial portion 18″ of the syringe guide 10″ includes passageways 30″ formed therein to provide a view of the syringe being used to extract medication from the medication vial. Those skilled in the art will also appreciate that the passageways 30″ formed in the medial portion 18″ of the syringe guide 10″ also advantageously allows a user to readily grip a portion of a syringe being used to extract medication from the medication vial.

The syringe guide 10, 10′, 10″ according to the present invention may advantageously be injection molded of a plastic material. Those skilled in the art will appreciate that the syringe guide 10, 10′, 10″ may include a light source formed therein. The light source may, for example, be a light emitting diode (LED) that may be molded into the body of the syringe guide. It may be preferably to mold the LED into the base of the top portion and/or the base of the medial portion. Those skilled in the art will appreciate that a power source may also be carried by the syringe guide to provide power to the LED. The remaining features of this embodiment of the syringe guide 10′ are similar to those of the first embodiment of the syringe guide 10, are labeled with prime notation and require no further discussion herein.

As also illustrated in FIGS. 12-18 indicia may be positioned on a portion of the syringe guide. The indicia may be used for advertising purposes, or for any other purposes as understood by those skilled in the art. The indicia may be positioned between the passageways on the medial portion, adjacent the base thereof. Those skilled in the art will appreciate, however, that the indicia may be positioned along any other body portion of the syringe guide. The indicia may, for example, be positioned on a body portion of the syringe guide during the injection molding process. Those skilled in the art will appreciate, however, that the indicia may be positioned on the body portion of the syringe guide in any other manner as well.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed.

That which is claimed is:

1. A syringe guide comprising:
a top portion adapted to receive a portion of a syringe;
a medial portion extending downwardly from the top portion; and
a bottom portion extending downwardly form the medial portion and adapted to receive a portion of a medication vial;
wherein the top portion includes top portion sidewalls and an end portion having an outer lip, the sidewalls defining a top portion having a semicircular shape;
wherein the medial portion includes medial portion sidewalls that extend substantially the length thereof and an upper portion including an upper lip having a semicircular shape, the medial portion sidewalls having at least one passageway formed therethrough;
wherein the bottom portion includes a lower end, bottom portion sidewalls connected to and extending upwardly from the lower end, an upper end connected to the bottom portion sidewalls, and a locking mechanism adapted to receive and hold the medication vial, the bottom portion sidewalls having a semicircular shaped to define an open side to receive the medication vial.

2. A syringe guide according to claim 1 wherein the outer lip of the top portion is beveled.

3. A syringe guide according to claim 1 wherein the at least one passageway formed in the medial portion sidewalls comprises a pair of opposing passageways.

4. A syringe guide according to claim 1 wherein the at least one passageway formed in the medial portion sidewalls have an ovular shape.

5. A syringe guide according to claim 1 further comprising a magnifier carried by the medial portion sidewalls.

6. A syringe guide according to claim 5 wherein the magnifier is a magnifying glass carried by the at least one passageway formed in the medial portion sidewalls.

7. A syringe guide according to claim 1 wherein the upper lip having the semicircular shape is positioned to oppose the top portion sidewalls having the semicircular shape.

8. A syringe guide according to claim 1 wherein the locking mechanism includes a lip that is formed along the lower end thereof.

9. A syringe guide according to claim 8 wherein the lip is defined by a structural element having an inner diameter that is smaller than an inner diameter of the bottom portion sidewalls.

10. A syringe guide according to claim 1 further comprising a needle guard positioned between the bottom portion and the medial portion, the needle guard including a passageway formed through a medial portion thereof.

11. A syringe guide comprising:
a top portion adapted to receive a portion of a syringe;
a medial portion extending downwardly from the top portion;
a bottom portion extending downwardly form the medial portion and adapted to receive a portion of a medication vial; and
a needle guard positioned between the bottom portion and the medial portion, the needle guard including a passageway formed through a medial portion thereof;
wherein the top portion includes top portion sidewalls defining a top portion having a semicircular shape;
wherein the medial portion includes medial portion sidewalls that extend substantially the length thereof and an upper portion including an upper lip having a semicircular shape, the medial portion sidewalls having at least one passageway formed therethrough and a magnifier carried thereby;
wherein the bottom portion includes a lower end, bottom portion sidewalls connected to and extending upwardly from the lower end, an upper end connected to the sidewalls, and a locking mechanism adapted to receive and hold the medication vial, the bottom portion sidewalls having a semicircular shaped to define an open side to receive the medication vial, the locking mechanism being defined by a structural element having an inner diameter that is smaller than an inner diameter of the bottom portion sidewalls.

12. A syringe guide according to claim 11 wherein the at least one passageway formed in the medial portion sidewalls comprises a pair of opposing passageways, each of the pair of opposing passageways having an ovular shape.

13. A syringe guide according to claim 11 wherein the magnifier is a magnifying glass carried by the at least one passageway formed in the medial portion sidewalls.

14. A syringe guide according to claim 11 wherein the upper lip having the semicircular shape is positioned to oppose the top portion sidewalls having the semicircular shape.

15. A method of using a syringe guide comprising a top portion adapted to receive a portion of a syringe, a medial portion extending downwardly from the top portion, a bottom portion extending downwardly form the medial portion and adapted to receive a portion of a medication vial, and a needle guard positioned between the bottom portion and the medial portion, wherein the top portion includes top portion sidewalls defining a top portion having a semicircular shape, wherein the medial portion includes medial portion sidewalls that extend substantially the length thereof and an upper portion including an upper lip having a semicircular shape, and wherein the bottom portion includes a locking mechanism, the method comprising:
engaging a medication vial with the locking mechanism so that the medication vial is held by the locking mechanism;
engaging a syringe with the top portion of the syringe guide; and
sliding the syringe through the medial portion of the syringe guide so that a needle of the syringe passes through a needle guard positioned between the medial portion and the bottom portion of the syringe guide.

16. A method according to claim 15 further comprising puncturing the medication vial carried by the bottom portion of the syringe guide and withdrawing medicine therefrom.

17. A method according to claim 16 further comprising moving the syringe to a disengaged position defined by the syringe being moved out of the guide.

18. A method according to claim 15 further comprising viewing a portion of the syringe through at least one passageway formed in the medial portion sidewalls, and wherein the at least one passageway has an ovular shape.

19. A method according to claim 18 wherein syringe guide includes a magnifier carried by the medial portion sidewalls, and wherein the magnifier is a magnifying glass carried by the at least one passageway formed in the medial portion sidewalls.

20. A method according to claim 15 wherein the syringe guide comprises a needle guard positioned between the bottom portion and the medial portion, the needle guard including a passageway formed through a medial portion thereof.
